(19) United States
(12) Patent Application Publication
(10) Pub. No.: US 2008/0060210 A1
(43) Pub. Date: Mar. 13, 2008

(54) COMPUTERIZED ANTLER SCORING SYSTEM

(76) Inventors: Blair S. Trout, Golden Valley, ND (US); Scott A. Wolff, Golden Valley, ND (US); Shane Wegner, Bismarck, ND (US)

Correspondence Address: COX SMITH MATTHEWS INCORPORATED, 112 EAST PECAN STREET, SUITE 1800, SAN ANTONIO, TX, 78205-1521, US

(21) Appl. No.: 11/470,901

(22) Filed: Sep. 7, 2006

(51) Int. Cl. G01B 3/12

(52) U.S. Cl. 33/773

(57) ABSTRACT

A system for creating, managing, and using a database comprising scoring data may involve receiving input signals from a measurement device, the input signals being representative of antler measurement data, calculating scoring data using various scoring methods, storing the scoring data in the database, creating customized trophy certificates containing the scoring data, and displaying summary lists of the scoring data in response to user queries of the database.

### CROSS-REFERENCE TO RELATED APPLICATIONS

Not applicable.

### COPYRIGHT NOTICE

This application contains material that is subject to copyright protection. Such material may be reproduced by any person exactly as it appears in the Patent and Trademark Office patent files or records. The copyright owner otherwise reserves all rights to such material.

### FIELD

The present application relates generally to antler scoring systems and more specifically to a computerized antler scoring system for measuring antlers and displaying scoring information.

### BACKGROUND

Antler measuring systems have been in use for years. The three most commonly utilized antler measuring systems are the Buckmasters Trophy Records (“BTR”), Safari Club International (“SCI”), and Boone & Crockett (“B&C”) scoring systems. All of those antler scoring systems provide a “score sheet” for an “official measurer” to record various measurements such as the number of points on the left and right antlers, the tip-to-tip spread, the greatest spread between the antlers, the inside spread of the main beams, total lengths of abnormal points, length of main beam, length of each individual point, circumference at smallest place between burr and first point, circumference at smallest place between each of the points and various other required measurements. These calculations are combined into a formula to generate a “final score” that is utilized to provide the overall score for the antlers. The formula may be comprised of various equations that provide a consistent scoring system.

U.S. Pat. No. 6,889,444 to Trout et al., incorporated herein by this reference, discloses an antler measurement device that may be used to collect the relevant measurements of an antler and to electronically calculate scoring data based on the popular scoring systems described above.

### SUMMARY

A system for creating, managing, and using a database comprising scoring data may involve receiving input signals from a measurement device, the input signals being representative of antler measurement data, calculating scoring data using various scoring methods, storing the scoring data in the database, creating customized trophy certificates containing the scoring data, and displaying summary lists of the scoring data in response to user queries of the database.

### BRIEF DESCRIPTION OF THE DRAWINGS

FIG. 1 is a schematic diagram that depicts one embodiment of a computerized antler scoring system having an antler scoring device connected to a computer.

FIG. 2 is a screen shot that depicts one embodiment of a user interface that may be provided by a computerized antler scoring system for displaying scoring information for a particular set of antler measurements.

FIG. 3 is a screen shot that depicts one embodiment of a user interface that may be provided by a computerized antler scoring system for establishing communication with an antler scoring device.

FIG. 4 is a flowchart of an Auto Scan routine used to identify an antler scoring device.

FIG. 5 is a screen shot that depicts one embodiment of a user interface that may be provided by a computerized antler scoring system for entering hunter information.

FIG. 6 is a flowchart of a Calculate Score routine used to calculate scoring information for a particular set of antler measurements.

FIG. 7 is a screen shot that depicts one embodiment of a user interface that may be provided by a computerized antler scoring system for creating customized trophy certificates.

FIG. 8 is a screen shot that depicts one embodiment of a user interface that may be provided by a computerized antler scoring system for database selection.

FIG. 9 is a screen shot that depicts one embodiment of a user interface that may be provided by a computerized antler scoring system for searching a database of stored scoring information.

FIG. 10 is a screen shot that depicts one embodiment of a user interface that may be provided by a computerized antler scoring system for generating a score list report.

FIG. 11 is a screen shot that depicts one embodiment of a user interface that may be provided by a computerized antler scoring system for allowing users to edit classification data.

### DETAILED DESCRIPTION

As used herein, the following terms should be understood to have the indicated meanings:

When an item is introduced by “a” or “an,” it should be understood to mean one or more of that item.

“Active Record” means a set of measurement data that has been operated on or displayed by a computer program.

“Antler” means a hornlike projection that protrudes from the head of a deer, moose, elk, caribou, or other horned animal. An antler may or may not be branched and may or may not be deciduous.

“Antler measurement data” means information relating to the dimensions, placement, or orientation of an antler.

“Antler measurement device” means a machine capable of performing one or more measurements of an antler. An antler measurement device may perform such measurements via electronic, optical, or any other suitable means, and may or may not comprise a computer.

“Communications device” means a machine capable of transmitting or receiving information, such as but not limited to, devices having one or more data registers.

“Comprises” means includes but is not limited to.

“Comprising” means including but not limited to.

“Computer” means any programmable machine capable of executing machine-readable instructions. A computer may include but is not limited to a general purpose computer, microprocessor, computer server, digital signal processor, or a combination thereof. A computer may comprise one or more processors, which may comprise part of a single machine or multiple machines.

“Computer program” means a list of instructions that may be executed by a computer to cause the computer to operate in a desired manner.

“Computer readable medium” means an article of manufacture having a capacity for storing one or more computer programs, one or more pieces of data, or a combination thereof. A computer readable medium may include but is not limited to a computer memory, hard disk, memory stick, magnetic tape, floppy disk, optical disk (such as a CD or DVD), zip drive, USB drive, or combination thereof.

“Customized trophy certificate” means a printable document containing descriptive information relating to a particular animal harvesting event, the contents of which may be manipulated by the user of a computer program.

“Data” means information.

“Database” means a collection of data embodied in at least one computer readable medium and organized in a suitable way to permit a computer to select one or more desired pieces of such data.

“Data Register” means a piece of computer hardware capable of storing data.

“Display device” means a visual output device, which may include but is not limited to a cathode ray tube, liquid crystal display, light emitting diode, plasma screen, or any other suitable display device.

“Having” means including but not limited to.

“Query” means a request for information from a database.

“Raw data” means information in its originally acquired form.

“Scoring data” means information calculated from one or more pieces of antler measurement data, which may include but is not limited to any of the widely used antler measuring systems such as, for example, the Buckmasters Trophy Records (“BTR”), Safari Club International (“SCI”), and Boone & Crockett (“B&C”) scoring systems.

As shown in FIG. 1, a computerized antler scoring system 10 for measuring antlers and displaying scoring information may have an antler measurement device 12 and a computer 14. The antler measurement device 12 is capable of acquiring antler measurement data for one or more antlers, which may include, for example, the lengths and circumferences of various tines and the length of spreads, or distances, between tines. The antler measurement data may be transmitted from the antler measurement device 12 to a computer 14, either directly or through one or more intermediate components, using any suitable type of signal or communication hardware or protocols, whether wired (as through wire 16), wireless, or otherwise. For example, the antler measurement device 12 may communicate signals representative of the antler measurement data using serial ports, parallel ports, modems, Ethernet ports, USB ports, Firewire, RS232 ports, or any other suitable types of communication ports.

The computer 14 may also contain a computer program suited for analyzing, storing and displaying the antler measurement data. The computer program may be stored on any computer readable medium 18, or on any computer network in connection with the computer 14. The user may install the computer program by loading the computer readable medium 18 into the computer 14 or by downloading the computer program from a network in communication with the computer 14, such as, for example, the Internet.

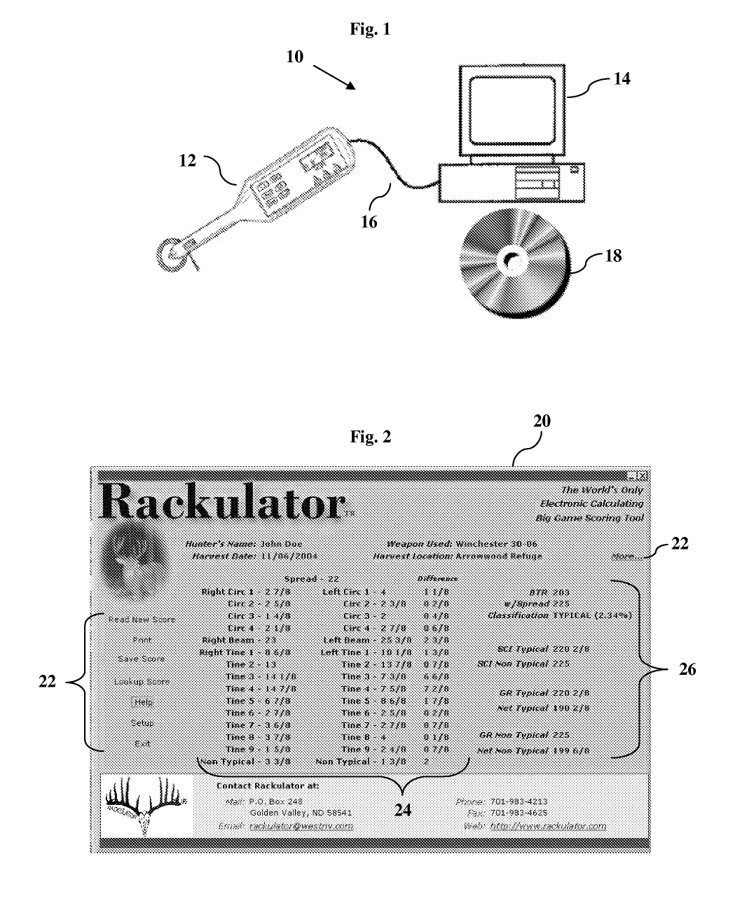

Turning now to FIG. 2, a main screen 20 of a user interface is shown that may at first be presented to the user after the user executes the computer program. The user may be presented with several selectable links or buttons 22, including, for example, and not by way of limitation, “Read New Score,” “Print,” “Score List,” “Save Score,” “Lookup Score,” “Edit List,” “Database,” “Help,” “Setup,” “More . . . ,” and “Exit.” Selectable links or buttons 22 may be selected by any suitable method, such as clicking, highlighting, touching, pressing a key, activating by voice, or any other method, and such selection may be made using any suitable input device, such as a mouse, trackball, keyboard, touch screen, voice recognition device, or light pen, for example. Alternatively, the functions associated with such buttons 22 could be selected via a pull down menu or any other suitable means. The user may select any of these links or buttons 22, the functionality of which is discussed further below. If the computer program has previously been used to record and display antler measurements and scoring information, then the main screen 20 may display measurement information 24 from the last Active Record inputted from the antler measurement device 12.

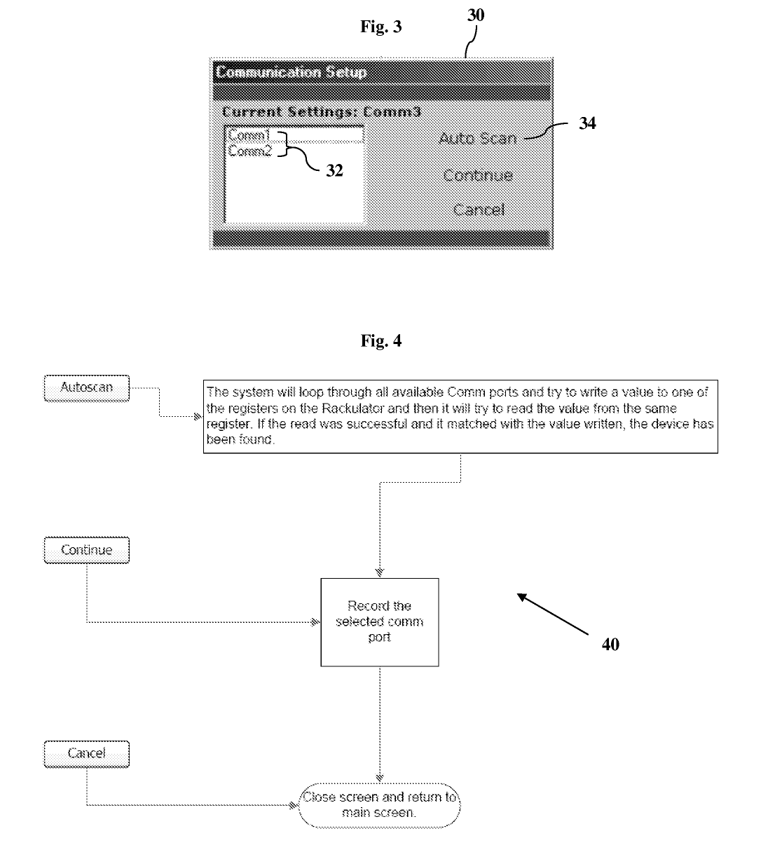

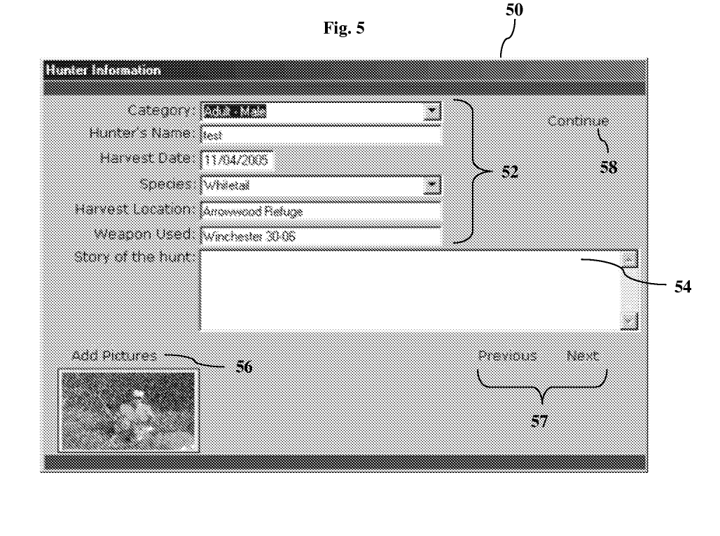

To ensure that the computer program is able to communicate with the antler measurement device 12 before the raw data is collected, the user may first select the “Setup” link 22 from the main screen 20, which may activate a communication setup screen 30 such as, for example, the screen depicted in FIG. 3. The communication setup screen 30 displays the serial communication ports 32 which may be available to the computer 14 on a connected serial bus, though a person having ordinary skill in the art will understand that various other communication devices may be used. The user may then manually select a communication port 32, or may select the “Auto Scan” link 34 to initiate the autoscan procedure 40, a description of which is depicted in the flowchart of FIG. 4. During the autoscan procedure 40, the computer program will attempt to write at least one data value to at least one Data Register of the antler measurement device 12 for a currently tested communication port 32. The computer program will then attempt to read at least one data value from that same Data Register and will compare the values written and the values read. If the written and read values are identical, the computer program will select the currently tested communications port 32 as the active port. If the written and read values do not match, the computer program will select another communications port 32 and begin the test anew. If the autoscan procedure 40 tests every communications port 32 and no port is selected, the computer program may return an error message stating that no antler measurement device 12 was detected.

Returning now to FIG. 2, if the user selects the selectable link 22 labeled “Read New Score” from the main screen 20, the computer program may first check to see whether measurement information 24 is displayed on the main screen 20. If measurement information 24 is displayed, the computer program may then save the previous measurement information 24 to a database accessible to the computer program. If there is no measurement information 24 displayed, or if the measurement information 24 has already been saved to the database, then the computer program may communicate with the antler measurement device 12 so as to collect the raw data stored on the antler measurement device 12. To collect the raw data, the computer program will iteratively read and store in memory the values contained within the Data Registers of the antler measurement device 12. In one embodiment of the present invention, the antler measurement device 12 may contain thirty-two Data Registers for storing measurement data. Of course, any desirable amount of memory may be provided in antler measurement device 12.

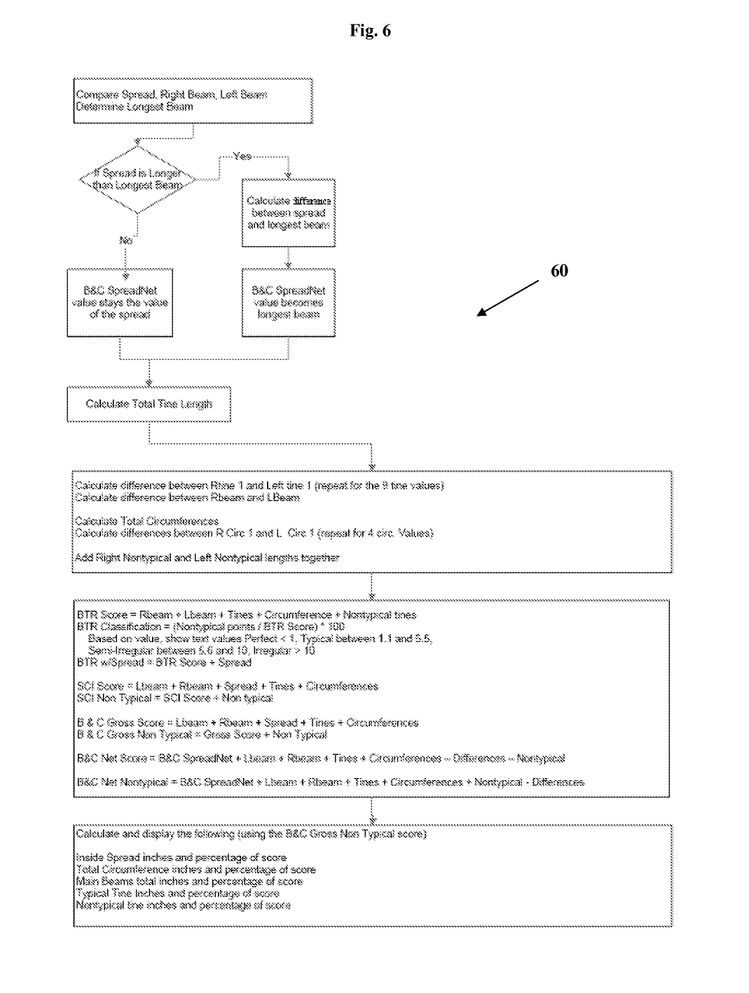

Once the data has been read from the antler measurement device 12, the computer program may open an information screen such as, for example and not by way of limitation, the hunter information screen 50 depicted in FIG. 5. Using the hunter information screen 50, the user may input descriptive information 52 relating to the antler measured including, for example, the hunter's sex, age, and name; the date and location of the hunt; the species of animal; and the weapon used. The user may also enter a narrative of the hunt using the text box 54 and may attach photographs of the hunt by selecting the selectable link or button 56. If multiple photographs have been attached, the user may navigate through the attached photographs by selecting the selectable links 57 labeled “Previous” and “Next.” The user may view the photograph in larger size by double-clicking the photograph. Further, if the user wishes to remove a particular photograph, the user may do so by right-clicking on the photograph the user wishes to delete with a mouse, for example, which may result in a contextual pop-up menu listing several functions, including a function to remove the selected photograph. Another function listed in the contextual pop-up menu may allow the user to specify that the selected photograph will be used on all printed trophy certificates, the production of which is discussed further below. The computer program may visually identify the photograph selected for use on printed trophy certificates by, for example, placing a specially-colored border around the photograph. In one embodiment of the graphical user interface, the photograph selected for use on printed trophy certificates is denoted with a tan border, though a person having ordinary skill in the art will understand that any suitable indication may be used to identify the selected photograph, such as alphanumeric characters, symbols, patterns, colors, or designs, for example.

When the user has finished entering the descriptive information 52, the narrative in text box 54, and has attached relevant photographs, if desired, the user may then select the selectable link 58, labeled “Continue,” to return to the main screen 20. Of course, the user may select the link 58 at any time and may enter only some, or none, of the aforementioned data. Returning now to the main screen 20 of FIG. 2, the measurement information 24 displayed now represents the measurement information read from the antler measurement device 12. Additionally, a number of calculated scores 26 may appear, which are based upon the measurement information. As previously disclosed herein, several scoring systems are known which use mathematical algorithms to assign numerical scores to antlers. In one embodiment of the present invention, the computer program may use the measurement information 24 to calculate scores 26 using the Buckmasters Trophy Records (“BTR”), Safari Club International (“SCI”), and Boone & Crockett (“B&C”) scoring systems, as depicted in the flow chart of FIG. 6. A person having ordinary skill in the art will understand that the algorithm 60 used to calculate scores 26 may be used to calculate any scoring system based on antler measurement information 24.

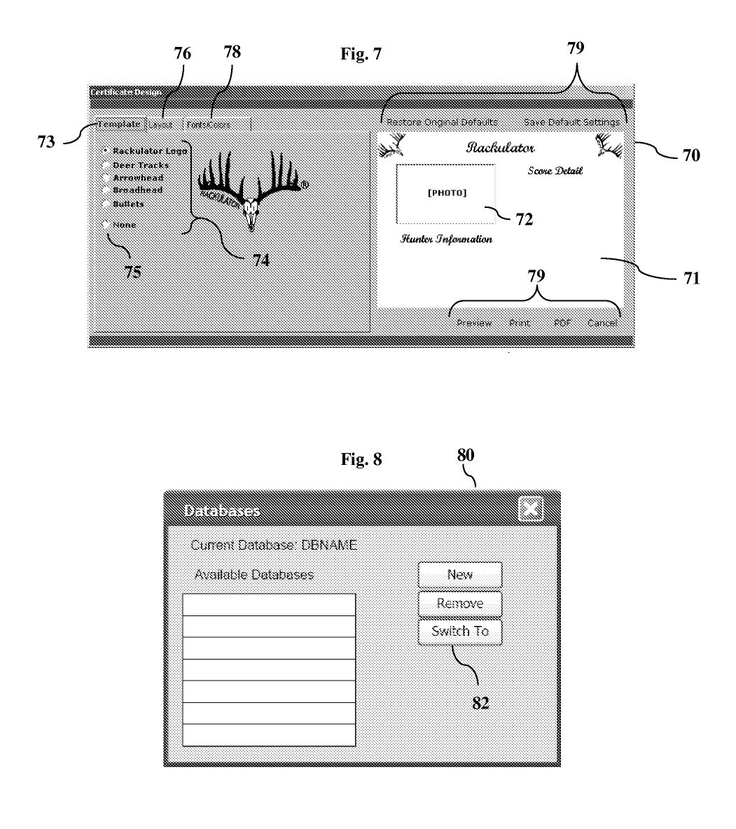

Returning again to FIG. 2, if the user selects the selectable link 22 labeled “Print” from the main screen 20, the computer program may activate a certificate design screen such as, for example, the screen 70 depicted in FIG. 7. The certificate design screen 70 of FIG. 7 allows the user to create a customized trophy certificate 71 for displaying scores 26, descriptive information 52, and/or photographs 72 of the hunt. The certificate design screen 70 may have a template tab 73, which may list certain design elements 74 that may be selected by the user. Alternatively, the user may choose to create a trophy certificate 71 without any design elements 74 by choosing the “None” option 75. The user may further customize the layout of the trophy certificate 71 by selecting various options presented on the layout tab 76, and may specify the background color as well as the color, type and size of fonts displayed on the trophy certificate 71 by selecting various options which may be presented on the fonts/colors tab 78. If a photograph 72 is selected from the hunter information screen 50 as described above, then the computer program may display the selected photograph 72 on the customized trophy certificate 71.

Still referring to FIG. 7, once the customized trophy certificate 71 has been created, the user may select the selectable link 79 labeled “Preview” to create a print preview of the trophy certificate 71. Finally, the user may print the trophy certificate 71 from the print preview or by selecting the clickable link 79 labeled “Print,” thereby sending the trophy certificate 71 to a default printer. Alternatively, if the user wishes to save the trophy certificate 71 in electronic format for later access and/or distribution, for example, by e-mailing the trophy certificate 71 or posting it on a network, the user may select the clickable link 79 labeled “PDF” to generate a file of the trophy certificate 71 in portable document format, which is a custom file format created by Adobe Systems Incorporated. However, a person having ordinary skill in the art will understand that the trophy certificate 71 may be saved in any desirable electronic file format for future access and distribution. Other selectable links 79 that may appear on the certificate design screen 70 include a link labeled “Save Default Settings,” which allows the user to set default design preferences for all trophy certificates 71, and “Restore Original Defaults,” which allows the user to revert to default design preferences in designing subsequent certificates.

Another selectable link 22 appearing on main screen 20 of FIG. 2 is the link labeled “Save Score,” which allows the user to save the measurement information 24, scores 26, descriptive information 52, attached photographs, and any other information to a selected database. The computer program may further allow the user to select a database by activating a database selection screen such as, for example, the screen 80 depicted in FIG. 8. The database selection screen 80 facilitates the addition, removal, or selection of particular databases, thereby allowing the user to maintain separate records for different hunting groups. Once the user chooses a database by selecting the selectable link 82 labeled “Switch To,” all subsequent records will be saved to that database unless another database is selected.

Yet another selectable link 22 appearing on main screen 20 of FIG. 2 is the link labeled “Lookup Score,” which allows the user to query a database for records relating to particular search criteria. For example, when this link is selected, the computer program may activate a database search screen such as, for example, the screen 90 depicted in FIG. 9. The database search screen 90 may contain various search fields 92 such as the hunter's name, the harvest date, the harvest location, or the weapon used. As the user enters information in one or more of the search fields 92, the results list 94 displays records matching the search criteria. To select a particular record from the results list 94, the user may simply double click the record or single click to highlight the record and then select the clickable link 96 labeled “Continue.” When a record is selected, the computer program may activate the main screen 20 and display the selected record therein.

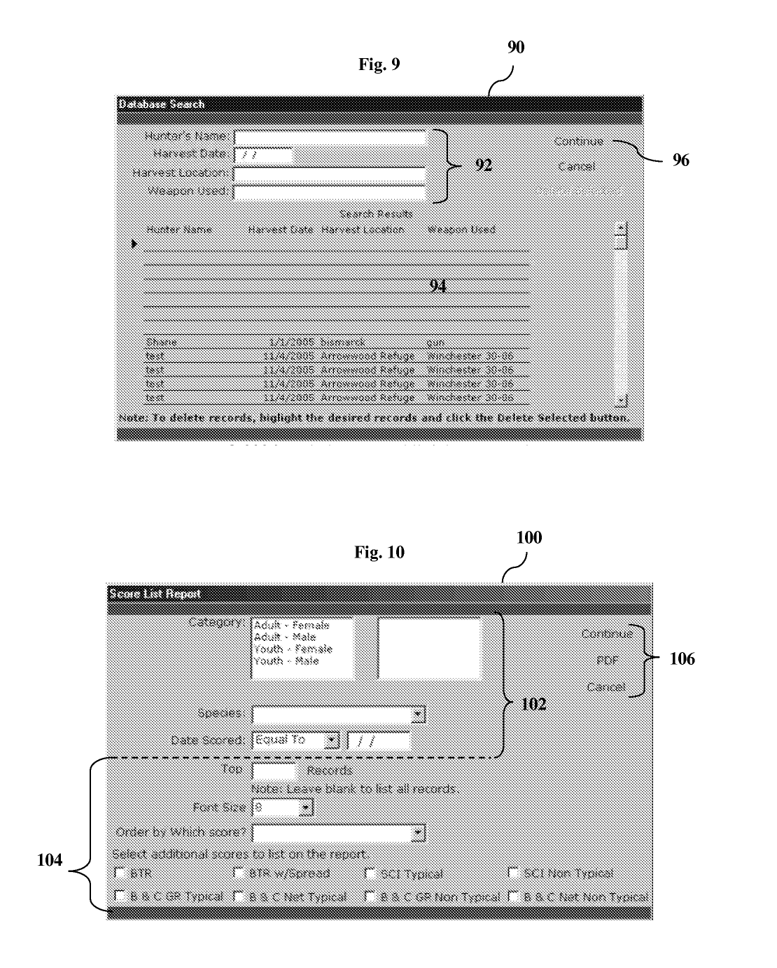

The computer program may also allow the user to create a summary report of scoring data by activating a score list report screen such as, for example, the screen 100 depicted in FIG. 10. The score list report screen 100 may contain various search fields 102 such as category of hunter, species, and date scored. Additionally, the score list report screen 100 may contain formatting criteria 104 such as top number of records to report, font size, score to be ranked, and additional scores to be listed on the report. As with the certificate design screen 70, the score list report screen 100 may contain selectable links 106 allowing the user to preview, print, and/or save the summary report.

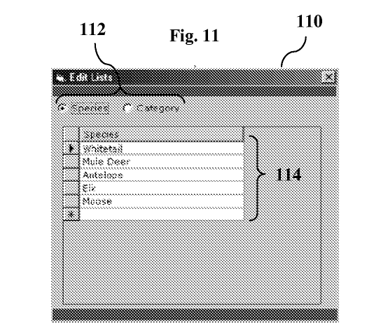

Further, the computer program may allow the user to edit lists of descriptive information used by the computer program in characterizing records. For example, the computer program may activate a list edit screen such as, for example, the screen 110 depicted in FIG. 11. The list edit screen 110 may contain various lists 112, such as a list of species or hunter categories. The user may select a particular list 112 and then add, remove, or change the descriptive information 114 appearing under that list. Finally, returning once again to the main screen 20 of FIG. 2, the computer program may contain a selectable link 22 labeled “Help,” the selection of which activates a help system well known in the art, and a clickable link 22 labeled “Exit,” the selection of which may terminate the computer program.

Certain embodiments of computer programs directed to the foregoing processes are shown in the attached Appendix, which is incorporated herein by reference. All of the methods disclosed herein may be performed, in whole or in part, by one or more computer programs embodied in one or more computer readable mediums.

A person having ordinary skill in the art will understand that the selectable links or buttons disclosed herein may all be selected by any suitable method, such as clicking, highlighting, touching, pressing a key, activating by voice, or any other method, and such selection may be made using any suitable input device, such as a mouse, trackball, keyboard, touch screen, voice recognition device, or light pen, for example. Alternatively, the functions associated with the selectable links or buttons disclosed herein could be selected via a pull down menu or any other suitable means.

Although the foregoing specific details describe certain embodiments of this invention, persons reasonably skilled in the art will recognize that various changes may be made in the details of this invention without departing from the spirit and scope of the invention as defined in the appended claims and considering the doctrine of equivalents. Therefore, it should be understood that this invention is not to be limited to the specific details shown and described herein.

What is claimed is:

1. A computer programmed with a computer program for storing and displaying antler measurement data, said computer program comprising instructions for:
receiving antler measurement data from an antler measurement device;
computing scoring data based on said antler measurement data; and
storing said scoring data in a database.

2. The computer of claim 1 wherein said computer program further comprises instructions for displaying said scoring data on a display device.

3. The computer of claim 1 wherein said computer program computes said scoring data pursuant to one or more scoring systems.

4. The computer of claim 3 wherein said one or more scoring systems is selected from the group consisting of the Buckmasters Trophy Records system, the Safari Club International system, and the Boone & Crockett system.

5. The computer of claim 1 wherein said computer program further comprises instructions for an auto scan procedure for identifying an antler measurement device, said auto scan procedure comprising:
writing at least one written data value to a memory associated with a communications device in communication with said computer;
reading at least one read data value from said memory;
identifying said communications device as an antler measurement device if said at least one written data value equals said at least one read data value; and
continuing said writing, reading, and identifying steps for each communication device in communication with said computer until an antler measurement device has been identified.

6. The computer of claim 1 wherein said computer program further comprises instructions for entering hunter information in one or more descriptive categories.

7. The computer of claim 6 wherein said descriptive categories are selected from the group consisting of Hunter Age, Hunter Sex, Hunter Name, Harvest Date, Species, Harvest Location, Weapon Used, Story of the Hunt, and Pictures.

8. The computer of claim 6 wherein said computer program further comprises instructions for allowing a user to add, remove, or edit said one or more descriptive categories from said database.

9. The computer of claim 1 wherein said computer program further comprises instructions for creating customized trophy certificates.

10. The computer of claim 9 wherein said computer program further comprises instructions for allowing a user to select different templates, layouts, and display options for said customized trophy certificates.

11. The computer of claim 9 wherein said computer program further comprises instructions for allowing a user to select one or more photographs to be displayed with said customized trophy certificates.

12. The computer of claim 1 wherein said computer program further comprises instructions for a database selection procedure allowing the user to add, remove, or select a particular database.

13. The computer of claim 1 wherein said computer program further comprises instructions for displaying one or more summary lists of said scoring data in response to one or more user queries of said database.

14. The computer of claim 13 wherein said user queries may be selected from the group consisting of Hunter Age, Hunter Sex, Hunter Name, Harvest Date, Species, Harvest Location, Weapon Used, Date Scored, Top Records, and Score System.

15. A computer readable medium comprising instructions for:
receiving antler measurement data from an antler measurement device;
computing scoring data based on said antler measurement data; and
storing said scoring data in a database.

16. The computer readable medium of claim 15 further comprising instructions for displaying said scoring data on a display device.

17. The computer readable medium of claim 15 wherein said scoring data is computed pursuant to one or more scoring systems.

18. The computer readable medium of claim 17 wherein said one or more scoring systems is selected from the group consisting of the Buckmasters Trophy Records system, the Safari Club International system, and the Boone & Crockett system.

19. The computer readable medium of claim 15 further comprising instructions for an auto scan procedure for identifying an antler measurement device, said auto scan procedure comprising:
writing at least one written data value to a memory associated with a communications device in communication with said computer;
reading at least one read data value from said memory;
identifying said communications device as an antler measurement device if said at least one written data value equals said at least one read data value; and
continuing said writing, reading, and identifying steps for each communication device in communication with said computer until an antler measurement device has been identified.

20. The computer readable medium of claim 15 further comprising instructions for entering hunter information in one or more descriptive categories.

21. The computer readable medium of claim 20 wherein said descriptive categories are selected from the group consisting of Hunter Age, Hunter Sex, Hunter Name, Harvest Date, Species, Harvest Location, Weapon Used, Story of the Hunt, and Pictures.

22. The computer readable medium of claim 20 further comprising instructions for allowing a user to add, remove, or edit said one or more descriptive categories from said database.

23. The computer readable medium of claim 15 further comprising instructions for creating customized trophy certificates.

24. The computer readable medium of claim 23 further comprising instructions for allowing a user to select different templates, layouts, and display options for said customized trophy certificates.

25. The computer readable medium of claim 23 further comprising instructions for allowing a user to select one or more photographs to be displayed with said customized trophy certificates.

26. The computer readable medium of claim 15 further comprising instructions for a database selection procedure allowing the user to add, remove, or select a particular database.

27. The computer readable medium of claim 15 further comprising instructions for displaying one or more summary lists of said scoring data in response to one or more user queries of said database.

28. The computer readable medium of claim 27 wherein said user queries may be selected from the group consisting of Hunter Age, Hunter Sex, Hunter Name, Harvest Date, Species, Harvest Location, Weapon Used, Date Scored, Top Records, and Score System.
